(19) United States
(12) Patent Application Publication
(10) Pub. No.: US 2023/0042646 A1
(43) Pub. Date: Feb. 9, 2023

(54) METHOD FOR REMOTELY MANAGING ACTIVE DIRECTORY

(71) Applicant: HashiCorp, San Francisco, CA (US)

(72) Inventors: Aareet Mahadevan, Vancouver (CA); Kyriakos Oikonomakos, London (GB)

(21) Appl. No.: 17/380,945

(22) Filed: Jul. 20, 2021

(51) Int. Cl. G06F 9/50; G06F 9/54; H04L 29/06

(52) U.S. Cl. CPC G06F 9/5072; G06F 9/5077; G06F 9/541; H04L 67/40

(57) ABSTRACT

An Active Directory (AD) of a cloud server maintains a set of cloud computing resources, each having a current configuration for managing the a resource on the cloud server. A set of changes of the current configuration to achieve a desired configuration for the resource are determined, and translated to a set of operations of a configuration framework required to achieve the desired configuration. A set of operations associated with a Group Policy Object (GPO) of the resource is determined. Upon determining conformance with the GPO, at least one script is generated to implement the set of operations, and which is executed over a remote management interface to carry out the set of operations to achieve the desired configuration for the resource.

### TECHNICAL FIELD

The disclosure generally relates to techniques for remotely managing resources of an Active Directory (AD) for a cloud computing infrastructure. Specifically, the present disclosure provides a technique to remotely configure and manage AD resources.

### BACKGROUND

Typically, a network of servers and workstations are grouped into a “domain” for a practitioner or an organization to manage the network of servers and workstations from a central location. A domain helps in the centralized management of the computers, workstations or servers, and users (e.g., user access) in an organization. Domain controllers are servers that authenticate users and authorize their access to computing resources in the domain. These resources include files, systems, applications and networks within the domain. The task of the domain controller is to ensure that only correct (i.e. authorized) users access the IT resources.

An Active Directory (AD) is a specialized directory service that manages (i.e. provides access, maintains, etc.) resources, such as information about users, network resources, printers, files, and other network objects. While it operates like a conventional telephone directory, a modern AD also arranges the users and Information Technology (IT) resources into groupings. The AD service in a cloud computing infrastructure provides users with a central management capability to manage users, groups, and permissions to various IT resources, and also allows users to define security policies, manage installed software, change registry settings, and control many aspects of a system. In some implementations, an AD controller is implemented on a server that runs on an AD service to make the above described management and configurations possible.

The AD may include a collection of services such as a Lightweight Directory Access Protocol (LDAP), a Domain Name System (DNS), and/or a Kerberos protocol, which is a network authentication protocol. The necessary services and management tools to achieve a desired configuration of the AD are installed in a Domain Controller (DC), which is also typically implemented by a server.

Certain methods allow users to manage AD resources in an automated and remote fashion, such as using a Powershell® framework (e.g., a task automation and configuration management framework from Microsoft, consisting of a command-line shell and associated scripting language) and .Net libraries. These methods require users to use specific libraries (e.g., GO library) with specific protocols (e.g., Server Message Block) to communicate with AD DCs and enable the DC to form a cloud computing infrastructure for managing AD resources. Certain cloud management or infrastructure platforms (e.g., Terraform) may not be able to manage AD resources if a specific library required to manage the AD is not supported by these platforms. Adding support for a new library or an API to a platform can be time consuming.

Accordingly, there is a need for a cloud computing platform and infrastructure that manages AD resources and assists practitioners with their administration tasks by managing the numerous Active Directory resources without using a specific library.

### SUMMARY

The present disclosure describes techniques for automatically managing Active Directory (AD) resources over a cloud computing platform. Various embodiments are described herein, including methods, systems, non-transitory computer-readable storage media storing programs, code, or instructions executable by one or more processors, and the like. Embodiments of the invention provide a novel way to configure resources within an AD.

In an example embodiment, a desired configuration for at least one Active Directory resource is received by a cloud computing platform from a client device. In the above embodiment, the desired configuration is a required framework within an AD for accessing, managing, and maintaining at least one AD resource. In the above embodiment, the desired configuration from the client device is received in form of a Desired State Configuration (DSC) script.

In some aspects, a computer-implemented method, and a cloud computing platform to execute the method, are presented. The method includes receiving, at a cloud server of a cloud computing platform from a client device, a current configuration for at least one resource associated with an Active Directory (AD) of the cloud server, the current configuration representing a configuration framework within the AD for managing the at least one resource on the cloud server. The method further includes determining, by at least one processor of the cloud server from the client device, a set of changes of the current configuration to achieve a desired configuration for the at least one resource. The method further includes translating, by the at least one processor, the set of changes to a set of operations of the configuration framework required to achieve the desired configuration, and determining whether the set of operations are associated with a Group Policy Object (GPO) associated with the at least one resource.

Upon determining that the set of changes are associated with the GPO, the method further includes generating, by the at least one processor, at least one script to implement the set of operations, and executing the at least one script over a remote management interface, the execution of the at least one script carrying out the set of operations to achieve the desired configuration for the at least one resource.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein.

Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a cloud computing platform, it should be readily understood that such features are not intended to be limiting. The claims that follow this disclosure are intended to define the scope of the protected subject matter.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a block diagram showing a high level overview of a cloud computing platform used to manage Active Directory resources according to certain embodiments;

FIG. 2 depicts an example of block diagram showing flow between components used to configure and manage Active Directory resources according to certain embodiments;

FIG. 3 depicts an example of a flowchart showing detailed steps performed to remotely configure and manage Active Directory resources;

FIG. 4 depicts an example of a flowchart showing steps performed by a cloud computing platform to remotely configure and manage Active Directory resources; and

FIG. 5 depicts a block diagram illustrating a computing system consistent with implementations of the current subject matter.

### DETAILED DESCRIPTION

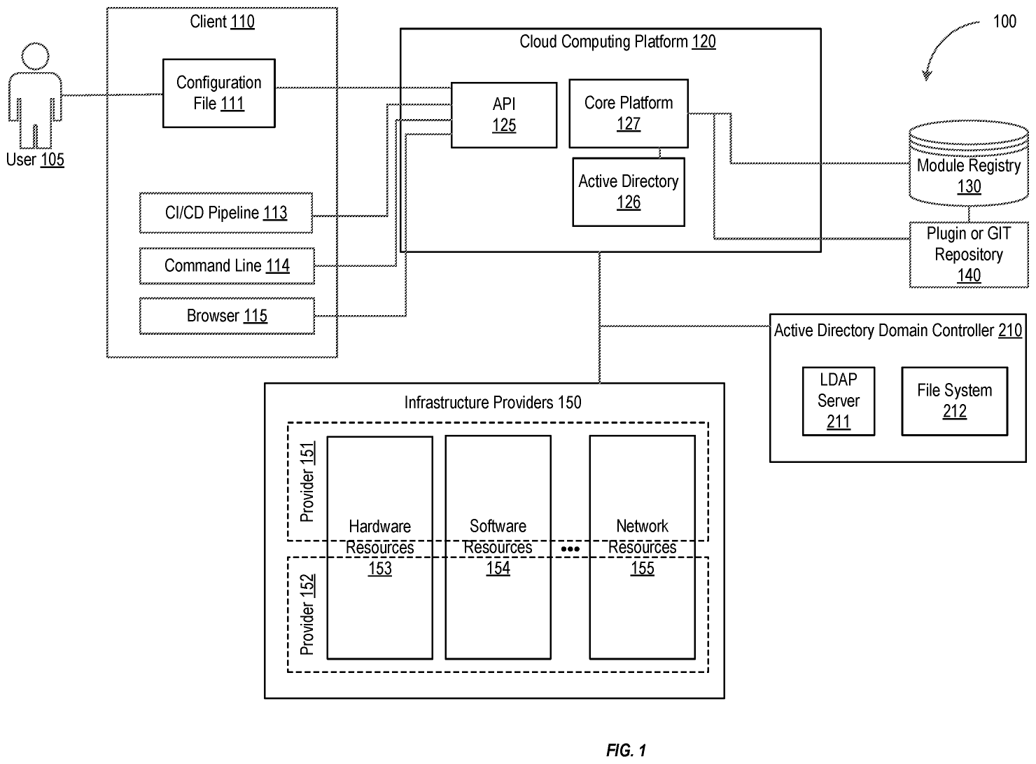

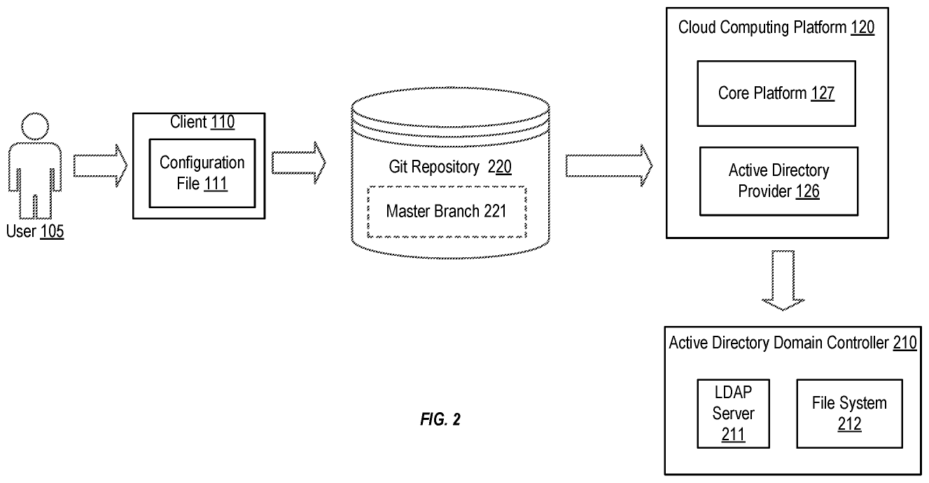

FIG. 1 depicts an example of a block diagram showing a cloud computing platform 100 to manage Active Directory (AD) resources, and FIG. 2 depicts a process flow diagram showing within the infrastructure platform to configure and manage AD resources, according to some implementations described herein.

In an example embodiment, a user 105 may be an individual or organization administrator that determines configuration for AD resources. A configuration file 111 may describe rules and a desired configuration for users, groups, and permissions to cloud based resources, security policies, software installations, registry settings, and many aspects of a system running Windows. In an example embodiment, code for the configuration file 111 may be created by a client device 110 associated with a user 100 or an organization. In this embodiment, the configuration file containing a desired set of configurations can be provided in a Desired State Configuration (DSC) script or similar file.

In an example embodiment, at least some code associated with the desired configuration within the configuration file 111 may be merged with or stored to a GIT repository 140, which is a distributed version-control system for tracking changes in source code during software development. Alternatively, it may be merged into a default branch of the GIT repository 220, which is also referred to as a “master” branch. Once the code associated with the desired configuration is merged with GIT repository 140, the resulting repository may have a single default branch, the master branch 221. The GIT repository is provided by a .git/folder inside a project which tracks all changes made to files.

In an example embodiment, upon merging the code into the GIT repository, a Continuous Integration and Continuous Delivery (CI/CD) pipeline 113 may be triggered to process the desired configuration. In the above embodiment, once the CI/CD pipeline is triggered, the pipeline may run one or more processors within the cloud computing platform 120 (e.g., Terraform) to determine necessary changes required to achieve the desired configuration. In an example embodiment, the one or more processors within the cloud computing platform 120 (e.g., Terraform Core) may determine the necessary changes required to achieve the desired configuration.

In the above embodiment, a core platform 127 of the cloud computing platform 120 may pass to an Active Directory 126 a set of necessary changes necessary to achieve the desired configuration. In an example embodiment, the Active Directory 126 interfaces with the cloud infrastructure platform 120 via a software development kit, for example, and may translate the list or set of changes provided by the infrastructure platform core 121 into AD-specific actions and/or operations.

In an example embodiment, the Active Directory 126 may connect to an Active Directory Domain Controller (AD DC) 210 and provide the set of specific operations to be performed. In an example embodiment, the AD DC 210 may perform the set of operations or action to achieve the desired configuration. In the above embodiment, the AD DC 210 may make an LDAP call or query to the Active Directory 126, alter files in a System Volume (SYSVOL) file system, or perform both actions to achieve the desired configuration. The SYSVOL is a shared directory within Microsoft Windows® that stores a copy of the domain's public files that must be shared for common access throughout a domain. The term SYSVOL as used herein refers to a set of files and folders that reside on the local hard disk of a domain controller (e.g., AD DC 210) in a domain.

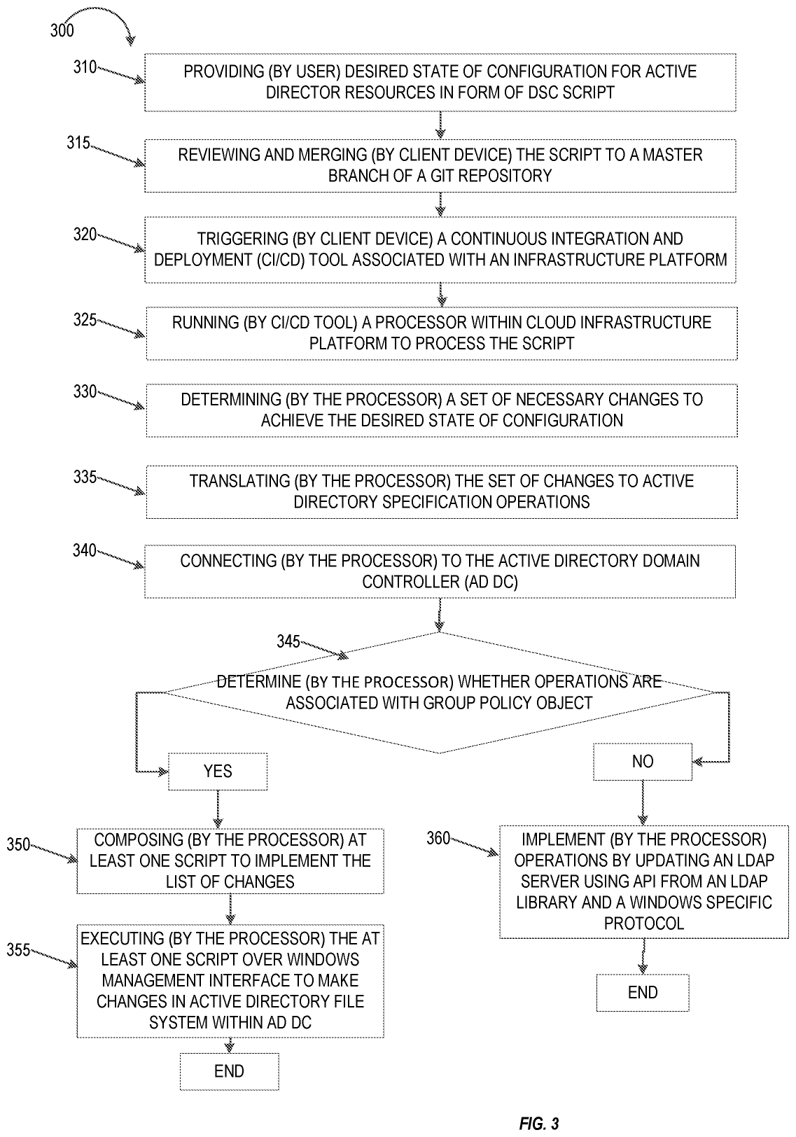

FIG. 3 depicts an example of a flowchart showing detailed steps performed to remotely configure and manage Active Directory resources. As discussed, in an example embodiment, a user 105 or an organization administrator may provide a desired configurations for one or more Active Directory related resources in step 310. In above embodiment, the user may provide a desired state of their Active Directory configuration in form of a Desired State Configuration (DSC) script.

In an example embodiment, in step 315, a client device 110 associated with the user 105 may review and merge the script to a master branch of a GIT repository 220. In an example embodiment, a client device 110 may use any of a command-line-interface or a browser to communicate a desired configuration with the GIT repository 140.

In an example embodiment, in step 320, the client device 110 triggers a Continuous Integration and Development (CI/CD) pipeline tool 113 associated with a cloud computing platform 120 (e.g., Terraform). The CI/CD pipeline tool 113 provides a platform to integrate a new software into established workflows automatically. In an example embodiment, CI/CD pipeline tool 113 may provide an automated and structured pipeline to integrate a desired configuration software or script with the infrastructure platform 120 (e.g., Terraform platform). In the above embodiment, a command-line or API-based interface may be used by the CI/CD pipeline tool 113 to integrate software into established workflows within the infrastructure platform 120. In an example embodiment, in step 325, the CI/CD tool may run on one or more processor(s) within a cloud computing infrastructure platform 120 to process the script.

In an example embodiment, in step 330, the one or more processor(s) within the infrastructure platform 120 may determine a set or a list of necessary changes required to achieve the desired configuration. For example, the core platform may use a graph builder implementing a graph walk algorithm, such as a directed acyclic graph, to generate and represent the steps (operators) and dependency relationships between them. The desired configuration may be a required framework to control and manage Active Directory resources. The required framework may be a group of object classes and attributes within Active Directory to control and manage the resources.

In an example embodiment, in step 335, the one or more processor(s) may determine Active Directory specific operations based on the received list of necessary changes. In the above embodiment, the Active Directory specific operations may be required to achieve the desired configuration.

In an example embodiment, in step 340, after determining the Active Directory specific operations to achieve the desired configurations, the one or more processor(s) connects to the Active Directory Domain Controller (AD DC) 210. The domain controller ensures that only correct users access the resources within a provider's network. For example, a system may allow a user to enter the username and password and sends this information to the domain controller. Then, the domain controller authenticates them with the AD service database. If the user entered details and the credentials stored in directory service are the same, the domain controller allows the user to access the resource. If not, the domain controller prevents the user from accessing the resource.

In an example embodiment, in step 345, the one or more processor(s) within the infrastructure platform 120 may further determine whether the operations are specific to changes within a Group Policy Object(s) (GPO) of the Active Directory resources. The GPO is a collection of Group Policy settings that define what a system will look like and how it will behave for a defined group of users.

In an example embodiment, a GPO may contain two parts: a user configuration (e.g., a user's authorization to access software) and a computer configuration (e.g., software setting). In an example embodiment, with a generated GPO, a brand-new entry within Active Directory may be created or new files on Active Directory domain controllers are created. En the above embodiment, a Group Policy enables policy-based administration (e.g., policy settings of resources are specified by an administrator) using Microsoft Active Directory services. A Group Policy Object (GPO), as discussed, is a virtual collection of policy settings.

In an example embodiment, upon determining in step 345 that the operations to achieve the desired configuration are associated with GPO, the one or more processor(s) within infrastructure platform 120 composes scripts to implement the operations. In the above example, the composed scripts comprise a sequence of installation operations or configuration data to achieve the desired configuration. At least one script is modeled using HashiCorp Configuration Language (HCL) or Extensible Markup Language (XML). The scripts may be used to implement changes or updates related to Active Directory objects, such as policies and other resources for users or groups of users, scripts-related portions of a group policy (such as the GPO), or to manage the installation and removal of software packages as part of a group policy, and implement other types of updates to group policies.

In an example embodiment, in step 350, the one or more processors within the infrastructure platform 120 may execute the scripts over a Windows Management Interface (e.g., WinRM) to make changes in a file system 212 of the AD DC 210. As discussed, typically, a GO library may be used to interface with a Lightweight Directory Access Protocol (LDAP) server 211 of the AD to make updates to resources related to the GPO. This library interface may not be supported within certain infrastructure platforms (e.g., Terraform). Accordingly, the one or more processor(s) within a cloud computing platform 120 may update resources involving the GPO to achieve a desired configuration without using GO library.

In this embodiment, the AD file system may reside within the AD DC 210. In the above embodiment, all file system operations may have to be done via scripts uploaded and executed over WinRM. In an example embodiment, one or more processor(s) within the infrastructure platform 120 may generate one or more scripts, such as Powershell scripts, that will perform the necessary actions, which provide the added benefit of being able to use AD-specific commands, if necessary.

In an alternative embodiment, in step 360, upon determining that the set of operations or actions are not related to the GPO, the one or processor(s) implements the operations to achieve the desired configuration. In the above embodiment, the operations not related to updating the GPO may include updating resources such as a user, group or data sources such as domain. In the above embodiment, these resources and data sources may be simple Lightweight Directory Access Protocol (LDAP) objects.

As discussed, LDAP is an integral part of how the Active Directory functions. LDAP is an application protocol for working with directory services. Directory services such as Active Directory store user and account information, and security information like passwords, and then allow the information to be shared with other devices on the network. LDAP is the language applications use to communicate with servers associated with directory services such as Active Directory service, and provides a way to “talk” to the Active Directory and transmit messages between the Active Directory and other parts of the provider's environment (e.g., infrastructure platform).

In the above embodiment, LDAP may be associated with one or more objects, where one or more sets of attributes are associated with objects that show certain characteristics of objects. (e.g., which group of users can access a certain workstation). Accordingly, configuration changes of LDAP objects may be directly performed by the one or more processors within the infrastructure platform.

In the above embodiment, a client device 110 (e.g., Provider) associated with the user 105 may require the following setup to achieve a desired configuration of at least one Active Directory resources using the above described steps within FIG. 3. The client device 110 or provider may be required to least support legacy Windows Servers versions, such as from 2012 (or higher). The provider or client 110 may be required to have Windows Remote Interface such as WinRM (Windows Remote Management) enabled within their device or system. The client 110 or provider may be required to allow access to WinRM via any firewalls.

In an example embodiment, a specific type of authentication within the provider may need to be enabled within the provider or client system. In an example embodiment, if a user decides to use a Basic or NT (New Technology) LAN Manager (NTLM) authentication method, these authentication methods may need to be enabled on the AD DC 210. “Basic authentication” prompts the user for a username and password to authenticate the user against the Windows Active Directory. NTLM authentication uses an encrypted challenge/response that includes a hash of the password.

In the above example embodiment, upon determining that the operations to achieve the desired configuration are associated with the GPO, the one or more processor(s) within infrastructure platform 120 composes scripts to implement the set of operations. The scripts may be used to implement changes or updates related to policies for user, group of users, scripts-related potion of a group policy, manage the installation and removal of packages as part of a group policy and other type of Group policies related updates.

In an example embodiment, prior to generating scripts to manage the above described Active Directory resources, a base GPO container may be created. As discussed, Group Policy settings for certain resources are contained in a GPO. A GPO can represent policy settings in the file system and in the Active Directory.

In an example embodiment, a GPO may be associated or linked to one or more Active Directory containers, such as a site, domain, or organizational unit. A GPO container is a base object for all Group Policy related to resources. Multiple containers may be linked to the same GPO, and a single container may have multiple GPO linked to it. Linking GPOs to Active Directory containers enable an administrator to implement Group Policy setting for a broad or narrow portion of the organization. In an example embodiment, the Group Policy Container may be a portion of GPO that resides on AD DC 210 in the domain. The Group Policy container may contain GPO properties, such as version information, GPO status, and other component settings.

In the above embodiment, creation of the GPO container may involve creating the appropriate LDAP object, retrieving its ACL (Active Directory List), creating policy specific directories in a predefined location on the Active Directory controller's file system, and then applying the retrieved ACL on these directories. In the above embodiment, Access Control Lists (ACLs) are settings that define user authorizations for objects, along with the type of access to Active Directory resources.

In an example embodiment, one or more processors within the infrastructure platform 120 may use GPO script resources to manage script-related portions of a group policy. In an example embodiment, a scripts-related group policy may be managed by writing INI (initialization) files into a GPO specific location in the file system of Active Directory Domain controller. INI is a file extension for an initialization file format used by Microsoft Windows. Generally, INI files are plain text (ASCII) and are used to set parameters for the operating system and some programs. In an example embodiment, the INI files may be generated by the one or more processors from resource attributes instead of requiring users to provide the INI files. For instance, a cloud architecture configuration file can be parsed by defined attributes, which can then be stored in an INI data structure. In some embodiments, INI files may manage logon/logoff scripts.

In an example embodiment, one or more GPO software installation type of resources may be used to manage installation and removal of software packages as part of a group policy. To define GPO software installation resources, one or more LDAP objects may be created, and an “Application Advertise Script” is generated in the correct GPO specific location. The Application Advertise Script is a file that contains a sequence of installation operations and configuration data for installing an application on a client machine. In the above embodiment, for software installation management, the format of the script may be binary and modeled using a configuration language such as the Hashicorp Configuration Language (HCL). All files required for the GPO, or any of the GPO's extensions, to operate are uploaded to the Active Directory Domain controller.

In an example embodiment, a GPO preference type resource may be used to manage preferences part of a group policy. In the above embodiment, the preferences may be managed via files located in a GPO specific path. In the above embodiment, an XML file may include a list of GPO policy preferences for the group policy. The XML, file may be provided by a user or provider to manage the GPO preferences for the group policy, such as, for example and without limitation, Data Source, Mapped Drives, Internet Settings, Registry Settings, Scheduled Tasks, or the like.

In an example embodiment, an HCL script may contain following code to manage GPO related Active Directory resources.

```
data ad_domain ″d″ {
name = ″″
dn = ″″ }
data ad_group ″parent″ {
name = ″parent group″
domain = ″″
dn = ″″ }
resource ad_user ″u″ {
    domain = data.ad_domain.d.dn
    username = ″kyriakos″
    # password is going to be set only on creation
    # and then ignore.
    password = ″supersecurepassword″
    # change_on_login will default to true
    change_on_login = falsefull_name = ″Kyriakos Oikonomakos″
    member_of = [ad_group.g.dn] }
  resource ad_group ″g″ {
    domain = data.ad_domain.d.dn
    group_name = ″testGroup″
    group_members = [ad_user.u.id]
    member_of = [data.ad_group.parent.dn] }
  resource ad_group_policy ″gp″ {
    name = ″″
    }
  resource ad_gp_scripts ″script″ {
    parentgp = ad_group_policy.gp.dn
    [... script specific attributes ...]
    }
  resource ad_gp_preferences ″pref″ {
    parent_gp = ad_group_policy.gp.dn
    [... preferences specific attributes ...]
    }
  resource ad_gp_software ″sw″ {
    parent_gp = ad_group_policy.gp.dn
    [... software packages specific attributes ...]
    }
```

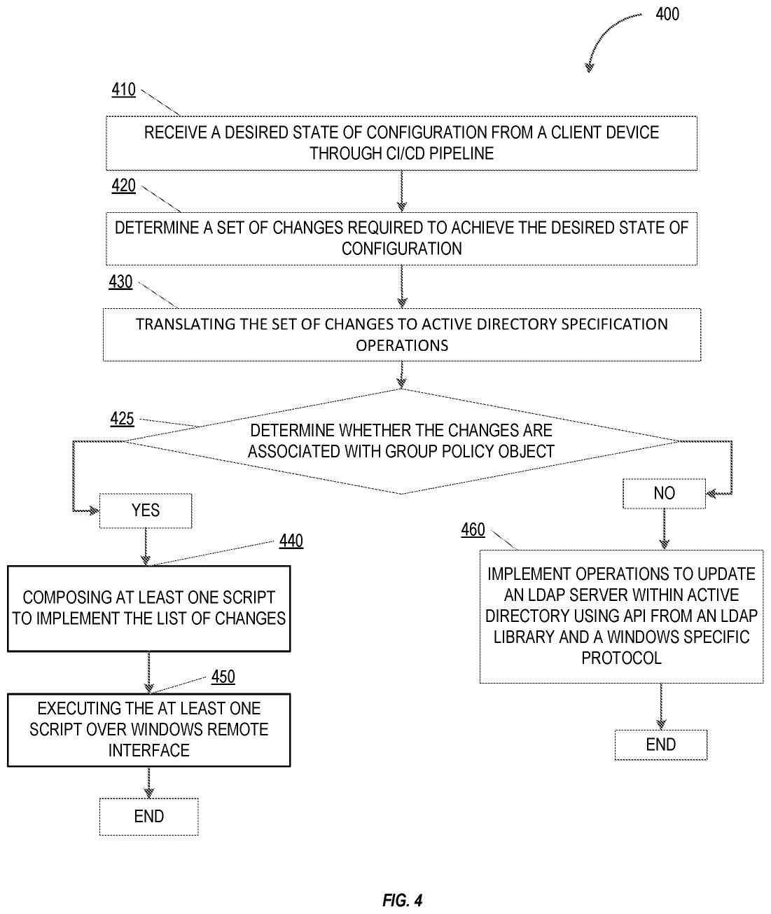

FIG. 4 depicts a flowchart showing steps performed by a cloud computing platform to remotely configure and manage Active Directory resources. As discussed, in an example embodiment, the infrastructure device or platform 120 receives a desired configuration through CI/CD tool 113 from a client device 110, as shown in step 410.

In an example embodiment, in step 420, the infrastructure device 120 may translate the set of changes into a set of actions or operations required to achieve the desired configuration. In step 430, the infrastructure platform 120 may determine whether the operations or actions are associated with a Group Policy Object (GPO), in step 425.

In an example embodiment, in step 440, the infrastructure device 120 may compose one or more scripts to implement a list of changes. In the above embodiment, the infrastructure device 120 in step 440 executes the scripts over a Windows Remote interface. In an example embodiment, the Windows Remote interface may be a WinRM (Windows Remote Management) interface. WinRM is Microsoft's implementation of WS-Management, a SOAP based protocol for management of devices and servers connect to remote Windows servers and run commands on them).

In an alternative embodiment, in step 450, if the operations are not associated with a GPO, then the infrastructure device may implement the operations to update an LDAP server within an Active Directory Domain Controller using an API from an LDAP library and a Window's® specific protocol. In an example embodiment, the infrastructure device may use Server Message Block (SMB) protocol to perform changes on LDAP server.

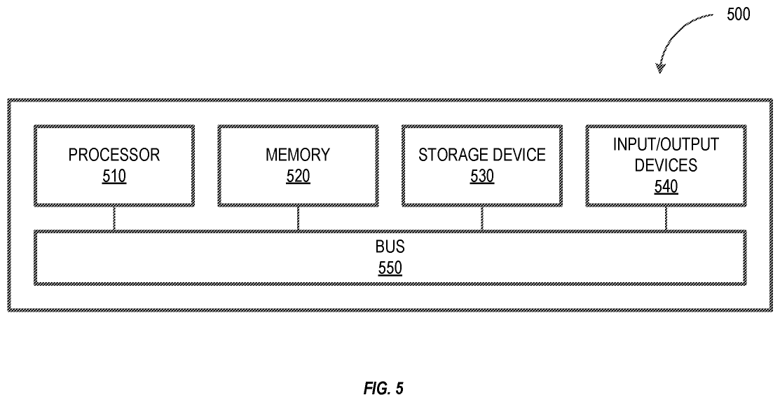

FIG. 5 depicts a block diagram illustrating a computing system 500 consistent with implementations of the current subject matter. Referring to FIGS. 1-2, the computing system 800 can be used to implement the information technology infrastructure platform 120 and/or any components therein.

As shown in FIG. 5, the computing system 500 can include a processor 510, a memory 520, a storage device 530, and input/output device 540. The processor 510, the memory 520, the storage device 530, and the input/output device 540 can be interconnected via a system bus 550. The processor 510 is capable of processing instructions for execution within the computing system 500. Such executed instructions can implement one or more components of, for example, the infrastructure platform 120. In some implementations of the current subject matter, the processor 510 can be a single-threaded processor. Alternatively, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, a tape device, a solid state device, and/or any other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 800 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 840. The user interface can be generated and presented to a user by the computing system 800 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include users and servers. A user and server are generally remote from each other and typically interact through a communication network. The relationship of user and server arises by virtue of computer programs running on the respective computers and having a user-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above.

In addition, the logic flows depicted in the accompanying figures and/or described herein do not necessarily require the particular order shown, or sequential order, to achieve desirable results. For example, the logic flows can include different and/or additional operations than shown without departing from the scope of the present disclosure. One or more operations of the logic flows can be repeated and/or omitted without departing from the scope of the present disclosure. Other implementations can be within the scope of the following claims.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied— for example, blocks can be re-ordered, combined, and/or broken into sub-blocks. Certain blocks or processes can be performed in parallel.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A computer-implemented method comprising:
receiving, at a cloud server of a cloud computing platform from a client device, a current configuration for at least one resource associated with an Active Directory (AD) of the cloud server, the current configuration representing a configuration framework within the AD for managing the at least one resource on the cloud server;
determining, by at least one processor of the cloud server from the client device, a set of changes of the current configuration to achieve a desired configuration for the at least one resource;
translating, by the at least one processor, the set of changes to a set of operations of the configuration framework required to achieve the desired configuration;
determining, by the at least one processor, whether the set of operations are associated with a Group Policy Object (GPO) associated with the at least one resource;
upon determining that the set of changes are associated with the GPO:
generating, by the at least one processor, at least one script to implement the set of operations; and
executing, by the at least one processor, the at least one script over a remote management interface, the execution of the at least one script carrying out the set of operations to achieve the desired configuration for the at least one resource.

2. The computer-implemented method of claim 1, wherein the remote management interface is configured to upload and run the at least one script on the cloud computing platform.

3. The computer-implemented method of claim 1, further comprising, upon determining the set of changes are not associated with the GPO of the at least one resource:
updating, by the at least one processor, a Lightweight Directory Access Protocol (LDAP) server within the AD according to the set of operations using an Application Programming Interface (API) of a LDAP library and a cloud server-specific protocol.

4. The computer-implemented method of claim 1, further comprising:
triggering, by the at least one processor, a Continuous Integration and Deployment (CI/CD) pipeline within the infrastructure platform; and
executing, by the at least one processor, the CI/CD pipeline to determine a set of changes required from a current configuration to achieve the desired configuration.

5. The computer-implemented method of claim 1, wherein the set of operations comprises creating at least one file on a file-system of an AD controller that hosts the AD.

6. The computer-implemented method of claim 1, wherein the at least one script is generated using a command-line shell and scripting language.

7. The computer-implemented method of claim 1, wherein the at least one script comprises a sequence of installation operations and configuration data to achieve the desired configuration, and wherein the at least one script is modeled using a configuration language specific to the cloud computing platform.

8. The computer-implemented method of claim 1, wherein the at least one script includes a sequence of operations to set preferences of at least one cloud-based resource for the client device, and wherein the at least one script is modeled using an Extensible Markup Language (XML).

9. The computer-implemented method of claim 1, wherein the desired configuration from the client device is received in a Desired State Configuration (DSC) script.

10. The computer-implemented method of claim 3, wherein the API used by the LDAP library communicates with the LDAP server.

11. A cloud computing platform comprising:
a processor; and
a non-transitory computer readable medium having instructions embodied thereon that when executed by the processor causes the processor to perform processes comprising:
receiving a desired configuration for at least one resource associated with an Active Directory (AD) of a cloud server of a cloud computing platform, wherein the desired configuration is represented as a configuration framework within the AD for managing the at least one resource on the cloud server;
determining a set of changes required from a current configuration to achieve the desired configuration;
translating the set of changes to a set of operations required to achieve the desired configuration;
determining whether the set of operations are associated with a Group Policy Object (GPO) of the at least one resource; and
upon determining that the set of changes are associated with the GPO:
generating at least one script to implement the set of operations; and
executing the at least one script over a remote management interface,
wherein the execution of the at least one script carries out the set of operations to achieve the desired configuration.

12. The cloud computing platform of claim 11, wherein the remote management interface is configured to upload and run the at least one script on the cloud computing platform.

13. The cloud computing platform of claim 12, further comprising, upon determining the set of changes are not associated with the GPO of the at least one resource:
updating a Lightweight Directory Access Protocol (LDAP) server within an Active Directory according to the set of operations using an Application Programming Interface (API) from a LDAP library and a cloud server-specific protocol.

14. The cloud computing platform of claim 11, wherein the set of operations comprises creating at least one file on a file-system of an AD controller that hosts the AD.

15. The cloud computing platform of claim 11, wherein the at least one script is generated using a command-line shell and scripting language.

16. The cloud computing platform of claim 11, wherein the at least one script comprises a sequence of installation operations and configuration data to achieve the desired configuration.

17. The cloud computing platform of claim 16, wherein the at least one script is modeled using a configuration language specific to the cloud computing platform.

18. The cloud computing platform of claim 11, wherein the at least one script comprises a sequence of operations to set preferences of at least one cloud based resource, wherein the at least one script is modeled using Extensible Markup Language (XML).

19. The cloud computing platform of claim 11, wherein the desired configuration is received in a Desired State Configuration (DSC) script.

20. The cloud computing platform of claim 13, wherein the API provided by the LDAP library communicates with the LDAP server.
